(19) United States
(12) Patent Application Publication
(10) Pub. No.: US 2026/0056110 A1
(43) Pub. Date: Feb. 26, 2026

(54) Method and Device for Determining the State of the Filter Unit of an Ink Supply System

(71) Applicant: Canon Production Printing Holding B.V., Venlo (NL)

(72) Inventors: Florian Hitzlsperger, Poing (DE); Ulrich Stöckle, München (DE); Christoph Rummelsberger, Ismaning (DE)

(21) Appl. No.: 19/306,195

(22) Filed: Aug. 21, 2025

(30) Foreign Application Priority Data
Aug. 22, 2024 (DE) 10 2024 123 992.1

(51) Int. Cl. G01N 15/08; B41J 2/175; B41J 2/18; B41J 2/20; B41J 3/46; B41J 29/00

(52) U.S. Cl. CPC G01N 15/0826; B41J 2/17563; B41J 2/17596; B41J 2/18; B41J 2/20; B41J 3/46; B41J 29/00; G01N 2015/084

(57) ABSTRACT

A device is described for determining the state of a filter unit of an ink supply system of a print bar of an inkjet printing device. The filter unit at a supply line to the print bar is arranged in series with a supply valve. The device is configured to determine an opening degree of the supply valve that thereby occurs while ink is conveyed with a defined target volumetric flow through the supply line. Furthermore, the device is configured to determine state information with respect to the state of the filter unit on the basis of the determined opening degree of the supply valve.

### CROSS-REFERENCE TO RELATED APPLICATION

This application claims priority to German Patent Application No. 10 2024 123 992.1 filed Aug. 22, 2024, the disclosure of which is hereby incorporated by reference in its entirety.

### BACKGROUND OF THE INVENTION

### Field of the Invention

The invention relates to a method and a corresponding device that are developed to determine the state of the filter unit for filtering the ink in an ink supply system of an inkjet printing device.

### Description of Related Art

An inkjet printing device for printing to a recording medium can comprise a print bar having one or more print heads with respectively one or more nozzles. The nozzles are respectively configured to eject ink droplets in order to print dots of a print image onto the recording medium. The individual print heads of a print bar are supplied with ink by an ink supply system, wherein the ink supply system typically has a filter unit that is designed to filter the ink for the print bar. With increasing operating time, the filter unit can have an increasingly large quantity of contaminants, and thus an increasingly high degree of coating, which ultimately can lead to a clogging of the filter unit.

### SUMMARY OF THE INVENTION

The present document deals with the technical object of efficiently and precisely determining the state, in particular the coating state, of the filter unit of the ink supply system of a print bar of an inkjet printing device, in particular in order to enable an optimized replacement of the filter unit. The object is respectively achieved by the features described herein.

According to one aspect, a device is described for determining the state of the filter unit of the ink supply system of a print bar of an inkjet printing device, wherein the filter unit at a supply line to the print bar is arranged in series with a supply valve, and wherein the filter unit is configured to capture contaminants from ink that is conveyed through the supply line. The device is configured to determine an opening degree of the supply valve, which opening degree thereby occurs while ink is conveyed with a defined target volumetric flow through the supply line. The device is also configured to determine state information with respect to the state of the filter unit on the basis of the determined opening degree of the supply valve, wherein the state information in particular indicates the coating state of the filter unit based on captured contaminants.

According to a further aspect, a method is described for determining the state of the filter unit of the ink supply system of a print bar of an inkjet printing device, wherein the filter unit at a supply line to the print bar is arranged in series with a supply valve, and wherein the filter unit is configured to capture contaminants from ink that is conveyed through the supply line. The method comprises determining an opening degree of the supply valve, which opening degree thereby occurs while ink is conveyed with a defined target volumetric flow through the supply line. Furthermore, the method also comprises determining state information with respect to the state of the filter unit on the basis of the determined opening degree of the supply valve.

### BRIEF DESCRIPTION OF THE DRAWINGS

In the following, exemplary embodiments of the invention are described in detail using the schematic drawings. Shown therein are:

FIG. 1 a block diagram of an example of an inkjet printing device;

FIG. 2 an example of an ink supply system for one or more print heads of a print bar of an inkjet printing device;

FIG. 3 an example of a time curve of the opening degree of the supply valve of the ink supply system; and

FIG. 4 a workflow diagram of an example of a method for determining state information with respect to the state, in particular the coating state, of the filter unit of an ink supply system.

The non-limiting embodiments of the present invention will be described with reference to the accompanying drawings. Elements, features and components that are identical, functionally identical and have the same effect are, insofar as is not stated otherwise, respectively provided with the same reference character.

### DESCRIPTION OF THE INVENTION

In the following description, numerous specific details are set forth in order to provide a thorough understanding of the embodiments of the present invention. However, it will be apparent to those skilled in the art that the embodiments, including structures, systems, and methods, may be practiced without these specific details. Well-known methods, procedures, components, and circuitry have not been described in detail to avoid unnecessarily obscuring embodiments of the invention. The connections shown in the figures between functional units or other elements can also be implemented as indirect connections, wherein a connection can be wireless or wired. Functional units can be implemented as hardware, software or a combination of hardware and software.

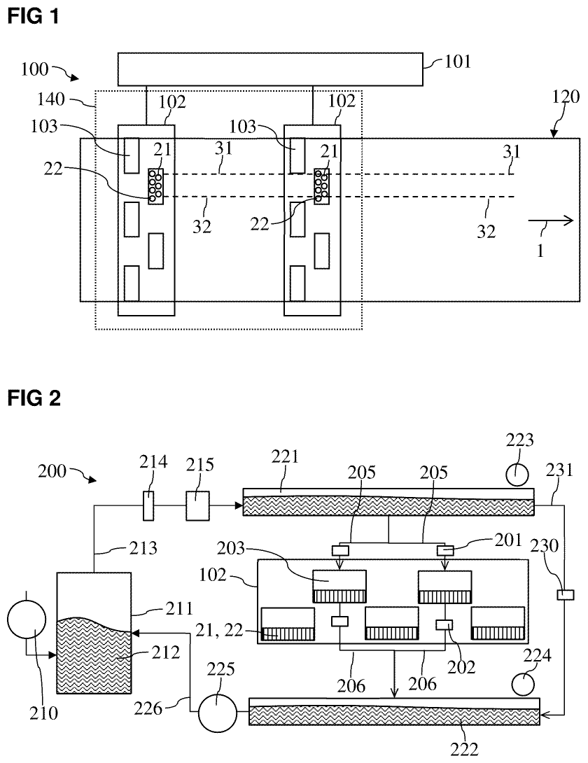

The printing device 100 depicted in FIG. 1 is designed for printing to a recording medium 120 in the form of a sheet or page or plate or belt. The recording medium 120 can be produced from paper, paperboard, cardboard, metal, plastic, textiles, a combination thereof, and/or other materials that are suitable and can be printed to. The recording medium 120 is guided through the print group 140 of the printing device 100 along the transport direction 1, represented by an arrow.

In the depicted example, the print group 140 of the printing device 100 comprises two print bars 102, wherein each print bar 102 can be used for printing with ink of a defined color, for example black, cyan, magenta, and/or yellow, and MICR ink if applicable. Different print bars 102 can be used for printing with respective different inks. Furthermore, the printing device 100 typically comprises at least one fixing or drying unit that is not shown in FIG. 1 and that is configured to fix a print image printed onto the recording medium 120.

A print bar 102 can comprise one or more print heads 103 that are possibly arranged side by side in a plurality of rows in order to print the dots of different columns 31, 32 of a print image onto the recording medium 120. In the example presented in FIG. 1, a print bar 102 comprises five print heads 103, wherein each print head 103 prints the dots of a group of columns 31, 32 of a print image onto the recording medium 120. The number of print heads 103 of a print bar 102 can, for example, be 5, 10, or more.

In the embodiment depicted in FIG. 1, each print head 103 of the print group 140 comprises a plurality of nozzles 21, 22, wherein each nozzle 21, 22 is configured to fire or eject ink droplets onto the recording medium 120. For example, a print head 103 of the print group 140 can comprise multiple thousands of effectively utilized nozzles 21, 22 that are arranged along multiple rows transverse to the transport direction 1 of the recording medium 120. Dots of a line of a print image can be printed onto the recording medium 120 transverse to the transport direction 1, i.e. along the width of the recording medium 120, by means of the nozzles 21, 22 of a print head 103 of the print group 140.

The printing device 100 also comprises a control device 101, for example a driving hardware and/or a controller, that is configured to drive the actuators of the individual nozzles 21, 22 of the individual print heads 103 of the print group 140 in order to apply the print image onto the recording medium 120 depending on print data. In an exemplary embodiment, the control device 101 includes processing circuitry or at least one processor that is configured to perform one or more functions and/or operations of the control device 101, including activating the actuators of the individual nozzles 21, 22 of the individual print heads 103 of the print group 140 to apply the print image onto the recording medium 120 based on print data, processing print and/or other data, control one or more modes of the printing device 100 and/or controlling one or more operations of the printing device 100. In an exemplary embodiment, the control device 101 includes one or more interfaces (e.g. a wired and/or wireless input and/or output interface, transceiver, or the like) that are configured to receive or output data or information. For example, the control device 101 may receive signals generated by one or more components of the printing device 100 (e.g. from a user interface of the printing device 100) and/or output control signals to one or more components of the printing device 100. In an exemplary embodiment, the control device 101 includes a memory configured to store data/information, and/or store executable code that is executable by the processing circuitry to cause the processing circuitry or at least one processor to perform the operation(s) of the control device 101.

The print group 140 of the printing device 100 thus comprises at least one print bar 102 having K nozzles 21, 22 that can be arranged in one or more print heads 103 and that can be driven with a defined line timing in order to print a respective line with K pixels or K columns 31, 32 of a print image into the recording medium 120, for example with K>1000, said line running transverse to the transport direction 1 of said recording medium 120. In the shown example, the nozzles 21, 22 are installed immobile or fixed in the printing device 100, and the recording medium 120 is directed past the stationary nozzles 21, 22 with a defined transport velocity.

FIG. 2 shows an example of an ink supply system 200 that is designed to supply one or more print heads 103 of a print bar 102 with ink 212. One or more print heads 103 can thereby be assembled into a print head group 203, wherein the one or more print heads 103 of a print head group 203 are supplied with ink 212 via a common ink path, in particular via a common print head supply line 205 and/or via a common print head discharge line 206.

The ink supply system 200 comprises an ink container 211 for ink 212. Ink 212 can be pumped from an ink reservoir (not shown) into the ink container 211 using a pump 210. Ink 212 can be conducted from the ink container 211, via a supply line 213, to an input-side distributor unit 221. A filter unit 214 for filtering the ink 212, in particular for cleaning the ink 212, can be arranged at the supply line 213. A supply valve 215 can also be arranged at the supply line 213, which supply valve 215 can be opened or closed in order to vary the volumetric flow of ink 212 through the supply line 213. The supply valve 215 can be designed such that the opening degree of the supply valve 215 can be varied continuously, for instance between 0% and 100%. The supply valve 215 can be a proportional valve.

The ink supply system 200 comprises an input-side pressure sensor 223 that is configured to detect measured pressure values with respect to the physical pressure of the ink 212 in and/or at the input-side distributor unit 221.

Starting from the input-side distributor unit 221, the ink 212 can be conducted to the individual print head groups 203. A print head supply line 205 can respectively lead from the input-side distributor unit 221 to the individual print head groups 203 in order to guide ink 212 from the input-side distributor unit 221 to the respective print head group 203. The individual print head supply lines 205 can respectively be opened or closed by a supply line valve 201.

A respective print head discharge line 206 can also lead from the individual print head groups 203 to an output-side distributor unit 223 in which the ink 212 from the individual print head groups 203 is collected. The individual print head discharge lines 206 can respectively be opened or closed by a discharge line valve 202.

The print head supply lines 205, the supply line valves 201, the print head discharge lines 206, and the discharge line valves 202 for two print head groups 203 are shown by way of example in FIG. 2. The ink supply system 200 for each print head group 203 of the print bar 102 typically has a respective print head supply line 205, supply line valve 201, print head discharge line 206, and discharge line valve 202.

The ink supply system 200 can comprise an output-side pressure sensor 224 that is configured to detect measured pressure values with respect to the physical pressure of the ink 212 in and/or at the output-side distributor unit 222.

Ink 212 can be pumped by an output-side (negative pressure) pump 225—which is designed as a gear pump, for example—from the output-side distributor unit 22 into the ink container 211 via a discharge line 226.

The ink supply system 200 can also have a bypass line 231 via which ink 212 can be conducted directly from the input-side distributor unit 221, and past the one or more print head groups 203, to the output-side distributor unit 222. The bypass line 231 can be opened or closed via a bypass valve 230. The bypass valve 230 and the bypass line 231 are typically closed during the printing operation of the print bar 102. On the other hand, in a standby operation of the print bar 102 and/or of the ink supply system 200, the bypass valve 230 and the bypass line 231 can be opened in order to enable a circulation of the ink 212 and in order to thereby in particular avoid the drying out of ink 212 in the ink supply system 200, and/or in order to thereby prepare the print bar 102 for a subsequent printing operation.

As has already been explained, during the operation of the ink supply system 200, the filter unit 214 at the supply line 213 captures contaminants from the ink 212 that is supplied to the input-side distributor unit 221. As a result of this, the coating, or the degree of coating, of the filter unit 214 typically increases with increasing operating life of the ink supply system 200, which typically leads to an increase in the resistance of the filter unit 214 for ink 212 that flows through the filter unit 214. If the quantity of contaminants captured by the filter unit 214 reaches a defined quantity threshold, and/or if the degree of the coating of the filter unit 214 reaches a defined coating threshold, a clogging of the filter unit 214 can occur, such that the ink supply of the print bar 102, and therewith the printing operation of the print bar 102, are interrupted. In the present document, measures are described with which the state—in particular the coating state, for instance the degree of coating—of the filter unit 214 can be efficiently and precisely determined, in particular in order to enable a time-optimized replacement of the filter unit 214 by which the useful life of the filter unit 214 is maximized without negatively affecting the availability of the printing device 100.

The bypass valve 230 and the bypass line 231 can be opened during the standby operation of the print bar 102 and/or of the ink supply system 200. The output-side pump 225 can also be operated in order to pump ink 212 from the output-side distributor unit 222 into the ink container 211. Furthermore, the device 101 can be configured to adjust the pressure of the ink 212 in the input-side distributor unit 222 to a defined target pressure. Alternatively or additionally, the device 101 can be configured to effect a defined target volumetric pressure of the ink 212 through the supply line 213. In particular, this can be effected in that the opening degree of the supply valve 215 is adjusted depending on measured pressure values of the input-side and/or output-side pressure sensor 223, 224, and possibly using a regulation.

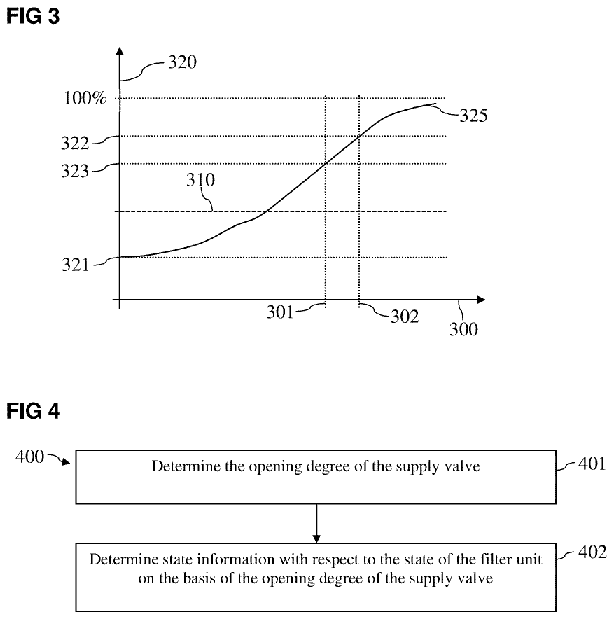

As is presented by way of example in FIG. 3, the output-side pump 225 can be operated during the standby operation of the ink supply system 200 in order to effect a defined volumetric flow 310 of ink 212 from the output-side distributor unit 222 to the ink container 211 and/or through the supply line 213, i.e. from the ink container 211 to the input-side distributor unit 221. The opening degree 320 of the supply valve 215 that thereby results can also be determined.

During the service life of the filter unit 214, the print bar 102 has repeated operating phases that are interrupted by standby phases. In the individual standby phases, the aforementioned standby operation of the ink supply system 200 can respectively be effected and the opening degree 320 of the supply valve 215 can respectively be determined. As a result of this, a time curve 325 of the opening degree 320 of the supply valve 215 results as a function of time 300. As is to be learned from FIG. 3, the opening degree 320 thereby typically increases with time 300 in order to compensate for the increasing degree of coating of the filter unit 214, and therewith for the increasing resistance of said filter unit 214. The opening degree 320 of the supply valve 315 is consequently a reliable indicator of the degree of coating of the filter unit 214.

In the example depicted in FIG. 3, the supply valve 215 first exhibits an initial opening degree 321 in order to set the target pressure and/or effect the target volumetric flow 310. With increasing service life of the filter unit 214, the opening degree 320 increases until, at a first point in time 301, a first opening degree 323 is reached that is preferably below a threshold 322 at which the filter unit 214 should or must be replaced. At the first point in time 301, the estimated point in time 302 at which the threshold 322 for the replacement of the filter unit 214 will be reached can be predicted on the basis of the time curve 325 of the opening degree 320. The estimated point in time 302 can be output via a user interface of the printing device 100 in order to inform the user of said printing device 100 that and, if applicable, when the filter unit 214 should or must be replaced. The availability of the printing device 100 can thus be comfortably and reliably increased. A maximum possible useful life of the filter unit 214 can thus also be effected.

The state of the filter unit 214 can thus be determined on the basis of the opening degree 320 of the supply valve 215 during the standby operation for recirculation of ink 212, if applicable in combination with the operating state of the output-side pump 225 in the return loop of the ink supply system 200. During the standby operation, a defined target volumetric flow 310 of ink 212 is produced, for example to prepare the printing device 100 for the subsequent printing operation. The ink 212 thereby flows out of the ink container 211, through the filter unit 214, through the supply valve 215, through the input-side distributor unit 221, via the bypass line 231 to the output-side distributor unit 222, before the ink 212 is conveyed again into the ink container 211 via the output-side pump 225, in particular via a gear pump. With increasing service life and/or with increasing coating of the filter unit 214, the opening degree 320 of the supply valve 215 increases in order to produce a defined target volumetric flow 310 of ink, for example 50 ml/min. A trend can be detected based on the time curve 325 of the opening degree 320. In particular, the point in time 302 can be predicted at which, due to the clogged filter unit 214, the supply valve 215 can no longer be opened sufficiently wide in order to be able to supply a sufficient high quantity of ink 212 for printing operation to the print bar 102. By predicting this point in time 302, it is enabled that the entire service life of the filter unit 214 is utilized and that downtimes of the printing device 100 are nevertheless avoided.

FIG. 4 shows a workflow diagram of an example of a, possibly computer-implemented, method 400 for determining the state of the filter unit 214 of the ink supply system 200 of a print bar 102 of an inkjet printing device 100. The method 400 can be executed by a control device 101 of the printing device 100. The filter unit 214 at a supply line 213 to the print bar 102 is arranged in series with a supply valve 215. The supply valve 215 can be arranged after the filter unit 214 in the flow direction of the ink 212 through the supply line 213. The filter unit 214 can be configured to capture contaminants from the ink 212 that is conveyed through the supply line 213. As a result of this, with time the filter unit 214 can have an increasingly large quantity of contaminants and/or be increasingly strongly coated. Alternatively or additionally, the state information can indicate the degree of coating and/or the degree of clogging of the filter unit 214.

The method 400 comprises the determination of the opening degree 320 of the supply valve 215 that thereby occurs while ink 212 is conveyed with a defined target volumetric flow 310, in particular through the supply line 213. For example, during the standby operation of the ink supply system 200, it can be effected that ink 212 flows with the defined target volumetric flow 310 through the supply line 213, in particular in order to effect a circulation of the ink 212 in the ink supply system 200, for instance in order to prevent a drying out of the ink 212 and/or in order to prepare the print bar 102 for the printing operation.

The target volumetric flow 310 of the ink 212 can be effected by setting one or more operating parameters, for example the rotation speed, of a pump 225 of the ink supply system 200, and/or by setting the opening degree 320 of the supply valve 215. The setting can be effected using a control loop. The opening degree 320 of the supply valve 215 that thereby occurs can be used as an indicator of the state of the filter unit 214, in particular the resistance of the filter unit 214. A relatively high opening degree 320 of the supply valve 215 typically indicates a relatively high resistance and/or a relatively high degree of coating and/or of clogging of the filter unit 214. On the other hand, a relatively low opening degree 320 of the supply valve 215 indicates a relatively low resistance and/or a relatively low degree of coating and/or of clogging of the filter unit 214.

The method 400 also comprises the determination 402 of state information with respect to the state of the filter unit 214 on the basis of the determined opening degree 320 of the supply valve 215. The state of the filter unit 214 can thus be efficiently and precisely determined, whereby the availability of the print bar 102 can in turn be increased.

Characteristic data, in particular experimentally determined characteristic data, that respectively indicate a value of a degree of coating and/or clogging of the filter unit 214 for a plurality of different values of the opening degree 320 of the supply valve 215 can possibly be prepared in advance. The value of the degree of coating and/or clogging of the filter unit 214 can then be determined as state information on the basis of the determined opening degree 320, i.e. of the determined value of the opening degree 320.

A device 101 is thus described for determining the state of the filter unit 214 of the ink supply system 200 of a print bar 102 of an inkjet printing device 100. The state information can indicate the coating state and/or the resistance of the filter unit 214 due to captured contaminants.

The ink supply system 200 can be designed to provide ink 212 for the N print head groups 203 or print heads 103 of the print bar 102, with N≥1, in particular N≥2. The ink supply system 200 can have an input-side distributor unit 221 that is designed to provide ink 212 at the input of the one or more ink supply channels of the N different print head groups 203 or print heads 103 of the print bar 102. Alternatively or additionally, the ink supply system 200 can have an output-side distributor unit 222 that is designed to receive ink 212 from the output of the one or more ink supply channels of the N different print head groups 203 or print heads 103 of the print bar 102.

The print bar 102 can have a respective supply line valve 201 for the N different print head groups 203 or print heads 103, which supply line valve 201 is designed to open or close a print head supply line 205 from the input-side distributor unit 221 to the respective print head group 203 or to the respective print head 103. Furthermore, for the N different print head groups 203 or print heads 103, the print bar 102 can have a respective discharge line valve 202 that is designed to open or close a print head group discharge line 206 from the respective print head group 203 or from the respective print head 103 to the output-side distributor unit 222. The supply line valves 201 and/or the discharge line valves 202 of the N print head groups 203 or print heads 103 thus enable a selective provisioning of ink 212 in the individual print head groups 203 or print heads 103.

The ink supply system 200 can comprise an input-side pressure sensor 223 that is configured to detect one or more measured pressure values with respect to the pressure of the ink 212 in the input-side distributor unit 221. Alternatively or additionally, the ink supply system 200 can comprise an output-side pressure sensor 224 that is configured to detect one or more measured pressure values with respect to the pressure of the ink 212 in the output-side distributor unit 222.

The supply valve 215 of the ink supply system 200 can be designed to vary the volumetric flow of ink 212 into the input-side distributor unit 221, and/or through the supply line 213 to the input-side distributor unit 221, by changing the opening degree 320 of the supply valve 215. The supply valve 215 is preferably designed such that the opening degree can be adjusted, in particular can be essentially continuously adjusted, between 0% (i.e. completely closed) and 100% (i.e. completely open).

The ink supply system 100 can comprise an input-side pump 210 that is designed to convey ink 212 into the input-side distributor unit 221, in particular via an and/or from an ink container 211 and/or via the supply valve 215 and/or via the distributor unit 214. Ink 212 for the N print head groups 203 can thus be reliably provided.

The ink supply system 100 can have an output-side pump 225 that is designed to pump ink 212 out of the output-side distributor unit 222, and in particular into the ink container 211. A through-flow of ink 212 through the N print head groups 203 can thus be reliably effected.

The filter unit 214 of the ink supply system 200 at the supply line 213 to the print bar 102, in particular to the input-side distributor unit 221, is arranged in series with the supply valve 215. The distributor unit 214 can be configured to capture contaminants from ink 212 that is conveyed through the supply line 213.

The ink supply system 200 can comprise a bypass line 231 that can be opened or closed via a bypass valve 230. The bypass line 231 can be designed to conduct ink 212 from the supply line 213 past the one or more print heads 103 or past the one or more print head groups 203 of the print bar 102. The bypass line 231 can in particular be configured to conduct ink 212 directly from the input-side distributor unit 221 to the output-side distributor unit 222, in particular without the ink 212 thereby being directed through the N print head groups 203 or print heads 103 of the print bar 102. The bypass line 231 can be used for a circulation of ink 212 within the ink supply system 200.

The device 101 is configured to determine an opening degree 320 of the supply valve 215 that thereby occurs while ink 212 is conveyed with a defined target volumetric flow 310 through the supply line 213.

The device 101 can be configured to operate the ink supply system 200 in a standby operation in which ink 212 is circulated with the defined volumetric flow 310 past the one or more print heads 103 or print head groups 203 of the print bar 102. The device 101 can be configured to open the bypass valve 230 for this purpose. The standby operation can take place in particular when the print bar 102 is in a standby state in which no dots are printed by the print bar 102. The standby operation of the ink supply system 200 can be effected in preparation for the printing operation of the print bar 102.

The device 101 can be configured to especially reliably determine the opening degree 320 of the supply valve 215 while the ink supply system 200 is operated in standby operation.

As has already been presented, the ink supply system 200 can comprise a pump 200, in particular an output-side pump 225, that is designed to convey ink 212 through the ink supply system 200. The pump 225 can in particular be designed to convey ink 212 from the supply line 213, downstream of the filter unit 214 and the supply valve 215, back into the ink container 211.

The device 101 can also be configured to operate the pump 225 and/or the supply valve 215 such that the defined target volumetric flow 310 of ink 212 is conveyed via the supply line 213. For this purpose, measured pressure values of the pressure of the ink 212 in the ink supply system 200, in particular in the supply line 213, can be determined, for example using the one or more pressure sensors 223, 224 of the ink supply system 200. The pump 225 and/or the supply valve 215 can be operated depending on the measured pressure values in order to effect that the determined target volumetric flow 310 of ink 212 is conveyed through the supply line 213.

A defined opening degree 320 of the supply valve 215 can thus be effected by adjusting the target volumetric flow 310 of ink 212 through the supply line 213. The device 101 is configured to determine state information with respect to the state of the filter unit 214 on the basis of the opening degree 320 of the supply valve 215. The state of the filter unit 214 can thus be determined especially efficiently and precisely.

The device 101 can be configured to output the state information via a user interface, in particular via a user interface of the printing device 100. The user of the printing device 100 can thus be precisely informed about when the filter unit 214 must be replaced. A maximization of the useful life of the filter unit 214 can thus be achieved without negatively affecting the availability of the printing device 100.

The device 100 can be configured to determine an opening degree 320 of the supply valve 215 that thereby respectively occurs at a sequence of successive points in time 300 at which ink 212 is respectively conveyed with the defined target volumetric flow 310 through the supply line 215, in order to determine a time curve 325 of the opening degree 320 of the supply valve 215 for the sequence of points in time 300. The ink supply system 200 can be respectively operated in standby operation at the individual points in time 300.

The state information with respect to the state of the filter unit 214 can be determined especially precisely on the basis of the determined time curve 325 of the opening degree 320 of the supply valve 215.

The device 101 can be configured to predict as state information, on the basis of the time curve 325 of the opening degree 320 of the supply valve 215, in particular on the basis of the time gradient of the time curve 325 of the opening degree 320 of the supply valve 215, an impending point in time 302 at which the filter unit 214 will be clogged and/or is to be replaced due to captured contaminants from the ink 212. For example, the time curve 325 of the opening degree 320 can be extrapolated into the future for this purpose. The operation of the ink supply system 200 and of the print bar 102 can be further optimized by predicting the replacement point in time 302.

Furthermore, in this document an ink supply system 200 is described that comprises the device 101 described in this document. Moreover, in this document a printing device 100 is described that comprises the ink supply system 200 described in this document.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

For the purposes of this discussion, the terms “processing circuitry” and “control device” shall be understood to be circuit(s) or processor(s), or a combination thereof. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary embodiments described herein, the memory is any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

1 transport direction (of the recording medium)
21, 22 nozzle
31, 32 column (of the print image)
100 printing device
101 (control) device
102 print bar
103 print head
120 recording medium
140 print group
200 ink supply system
201 supply line valve
202 discharge line valve
203 print head group
205 print head supply line
206 print head discharge line
210 input-side pump
211 ink container
212 ink
213 supply line
214 filter unit
215 supply valve
221 input-side distributor unit
222 output-side distributor unit
223 input-side pressure sensor
224 output-side pressure sensor
225 output-side (negative pressure) pump
226 discharge line
230 bypass valve
231 bypass line
300 time
301, 302 point in time
310 target volumetric flow of ink
320 opening degree
321 initial opening degree
322 opening degree threshold
323 first opening degree
400 method to determine the state of a filter unit
401-402 method steps

1. An inkjet printing device, comprising:
a print group comprising a print bar having an ink supply system;
a filter unit provided at a supply line to the print bar and arranged in series with a supply valve, the filter unit being configured to capture contaminants from ink that is conveyed through the supply line; and
a control device for determining a state of the filter unit of the ink supply system of the print bar, the control device comprising processing circuitry configured
to determine an opening degree of the supply valve that thereby occurs while ink is conveyed with a defined target volumetric flow through the supply line; and
to determine state information with respect to the state of the filter unit based on the determined opening degree of the supply valve; wherein the state information indicates a coating state of the filter unit due to captured contaminants.

2. The inkjet printing device according to claim 1, wherein the processing circuitry of the control device is further configured
to determine an opening degree of the supply valve that thereby respectively occurs at a sequence of successive points in time at which ink is respectively conveyed with the defined target volumetric flow through the supply line, in order to determine a time curve of the opening degree of the supply valve for the sequence of points in time; and
to determine state information with respect to the state of the filter unit based on the determined time curve of the opening degree of the supply valve.

3. The inkjet printing device according to claim 2, wherein the processing circuitry of the control device is further configured to predict as state information, based on the time curve of the opening degree of the supply valve, an impending point in time at which the filter unit will be clogged and/or is to be replaced due to captured contaminants from the ink.

4. The inkjet printing device according to claim 1, wherein the processing circuitry of the control device is further configured
to operate the ink supply system in a standby operation in which ink is circulated with the defined volumetric flow past one or more print heads of the print bar if the print bar is in a standby state in which no dots are printed by the print bar; and
to determine the opening degree of the supply valve while the ink supply system is operated in the standby operation.

5. The inkjet printing device according to claim 4, wherein
the ink supply system comprises a bypass line that can be opened or closed via a bypass valve;
the bypass line is configured to conduct ink from the supply line past the one or more print heads of the print bar; and
the processing circuitry of the control device is further configured to open the bypass valve in order to operate the ink supply system in the standby operation.

6. The inkjet printing device according to claim 1, wherein
the ink supply system comprises a pump that is configured to convey ink through the ink supply system; and
the processing circuitry of the control device is further configured to operate the pump and/or the supply valve such that the defined target volumetric flow of ink is conveyed via the supply line.

7. The inkjet printing device according to claim 6, wherein
the ink supply system comprises an ink container for ink; and
the pump is configured to convey ink from the supply line, downstream of the filter unit and the supply valve, back into the ink container.

8. The inkjet printing device according to claim 6, wherein the processing circuitry of the control device is further configured
to determine measured pressure values of a pressure of the ink in the ink supply system; and
to operate the pump and/or the supply valve depending on the measured pressure values, in order to effect that the defined target volumetric flow of ink is conveyed through the supply line.

9. The inkjet printing device according to claim 1, wherein the processing circuitry of the control device is further configured to output the state information via a user interface.

10. The inkjet printing device according to claim 9, wherein the user interface is a user interface of the printing device.

11. A method to determine a state of a filter unit of an ink supply system of a print bar of an inkjet printing device; wherein the filter unit at a supply line to the print bar is arranged in series with a supply valve; wherein the filter unit is configured to capture contaminants from ink that is conveyed through the supply line, the method comprising
determining an opening degree of the supply valve that thereby occurs while ink is conveyed with a defined target volumetric flow through the supply line; and
determining state information with respect to the state of the filter unit based on the determined opening degree of the supply valve; wherein the state information indicates a coating state of the filter unit due to captured contaminants.

12. The method according to claim 11, further comprising
determining an opening degree of the supply valve that thereby respectively occurs at a sequence of successive points in time at which ink is respectively conveyed with the defined target volumetric flow through the supply line, in order to determine a time curve of the opening degree of the supply valve for the sequence of points in time; and
determining state information with respect to the state of the filter unit based on the determined time curve of the opening degree of the supply valve.

13. The method according to claim 12, further comprising predicting as state information, based on the time curve of the opening degree of the supply valve, an impending point in time at which the filter unit will be clogged and/or is to be replaced due to captured contaminants from the ink.

14. The method according to claim 11, further comprising
operating the ink supply system in a standby operation in which ink is circulated with the defined volumetric flow past one or more print heads of the print bar if the print bar is in a standby state in which no dots are printed by the print bar; and
determining the opening degree of the supply valve while the ink supply system is operated in the standby operation.

15. The method according to claim 14, wherein
the ink supply system comprises a bypass line that can be opened or closed via a bypass valve;
the bypass line is configured to conduct ink from the supply line past the one or more print heads of the print bar; and
the method further comprises opening the bypass valve in order to operate the ink supply system in the standby operation.

16. The method according to claim 11, wherein
the ink supply system comprises a pump that is configured to convey ink through the ink supply system; and
the method further comprises operating the pump and/or the supply valve such that the defined target volumetric flow of ink is conveyed via the supply line.

17. The method according to claim 16, further comprising
determining measured pressure values of a pressure of the ink in the ink supply system; and
operating the pump and/or the supply valve depending on the measured pressure values, in order to effect that the defined target volumetric flow of ink is conveyed through the supply line.

18. The method according to claim 11, further comprising outputting the state information via a user interface.
